(19) United States
(12) Patent Application Publication
(10) Pub. No.: US 2018/0029360 A1
(43) Pub. Date: Feb. 1, 2018

(54) Method and controller to stabilize an ink meniscus in an inkjet printing system

(71) Applicant: Océ Holding B.V., Venlo (NL)

(72) Inventor: Ulrich Stoeckle, Muenchen (DE)

(73) Assignee: Océ Holding B.V., Venlo (NL)

(21) Appl. No.: 15/661,564

(22) Filed: Jul. 27, 2017

(30) Foreign Application Priority Data
Jul. 28, 2016 (DE) 10 2016 113929.7

(51) Int. Cl. B41J 2/045

(52) U.S. Cl. CPC B41J 2/04573; B41J 2/04586

(57) ABSTRACT

In an a method to stabilize the ink meniscus at a nozzle opening of a nozzle of a print head including the nozzle and one or more adjacent nozzles to the nozzle, the nozzle can be induced to generate a signal pulse at an activation time. The signal pulse can be a pre-fire pulse (e.g. a negative pressure reduction pulse), where, for example, no ink is ejected. The inducement to generate the pulse can depend on the number of adjacent nozzles that eject ink at the activation time. The negative pressure in the nozzle can then be reduced, and nozzle failures due to air suction may be avoided.

### CROSS REFERENCE TO RELATED APPLICATIONS

This patent application claims priority to German Patent Application No. 102016113929.7, filed Jul. 28, 2016, which is incorporated herein by reference in its entirety.

### BACKGROUND

The present disclosure relates to a method and a corresponding controller configured to stabilize the ink meniscus of a nozzle of an inkjet printing system.

An inkjet printing system typically comprises one or more print heads respectively having a plurality of nozzles, wherein each nozzle is configured to fire or eject ink droplets onto a recording medium. A nozzle thereby typically comprises a pressure chamber in which pressure is built up in order to generate an ink droplet. The pressure chambers of the individual nozzles of a print head may be connected with a common ink reservoir via one or more ink supply channels. Such a printing system is described in US2010/0053252A1, for example.

A print head having a relatively high density of nozzles, as presented in US2010/0053252A1, may lead to interactions between adjacent nozzles of a print head. The print quality of an inkjet printing system may thereby be negatively affected. In particular, failures of individual nozzles may occur due to the interactions.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a block diagram of an inkjet printing system according to an exemplary embodiment of the present disclosure;

FIG. 2 illustrates a nozzle according to an exemplary embodiment of the present disclosure;

FIGS. 3a, 3b, and 3c illustrate examples of activation situations of a series of adjacent nozzles according to exemplary embodiments of the present disclosure;

FIG. 3d illustrates print data for the activation of a series of adjacent nozzles according to an exemplary embodiment of the present disclosure;

FIG. 4 illustrates a workflow diagram of a method for stabilizing the ink meniscus of a nozzle of a print head according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to reduce the influence of adjacent nozzles on a nozzle in a print head in order to prevent failures of the nozzle, and thus to increase the print quality of an inkjet printing system.

According to one aspect, a method is described for stabilizing the ink meniscus at a nozzle opening of a first nozzle of a print head. The pressure chamber of the first nozzle is thereby connected via an ink supply channel with pressure chambers of one or more adjacent nozzles of the print head, wherein the one or more adjacent nozzles are activated simultaneously with the first nozzle at one or more activation points in time to print image points of a print image onto a recording medium.

In an exemplary embodiment, the method can include the determination of whether at least a portion of the one or more adjacent nozzles should eject ink at an activation point in time at which the first nozzle should eject no ink. For example, this may be determined on the basis of the print data of a print image to be printed. In an exemplary embodiment, depending on the determination, the method can include the activation of the first nozzle at the activation point in time with a negative pressure reduction pulse via which a negative pressure in the pressure chamber of the first nozzle is reduced (e.g. at least temporarily) without thereby producing an ink ejection. Air entrapment or air intake into an ink supply channel of the print head, and therefore nozzle failures, may be avoided via the selective insertion of negative pressure reduction pulses in one or more nozzles that should produce no ink ejection at an activation point in time.

According to a further aspect, the inkjet printing system can include a controller. The controller can be for a print head of the inkjet printing system. The controller can be configured to execute one or more methods according to exemplary embodiments of the present disclosure.

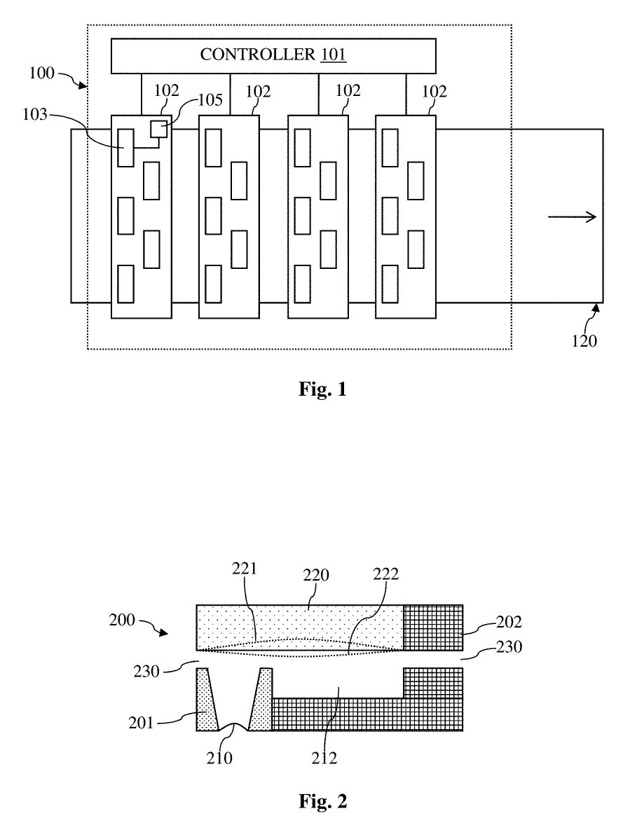

FIG. 1 shows a block diagram of an inkjet printing system 100 according to an exemplary embodiment of the present disclosure. The printing system 100 presented in FIG. 1 is configured for printing to a web-shaped recording medium 120 (also designated as a “continuous feed”). However, the aspects of the present disclosure are also applicable to printing systems 100 that are configured to print to a sheet-shaped or page-shaped recording medium 120. A web-shaped recording medium 120 is typically taken off from a roll (the take-off) and then supplied to the print group of the printing system 100. A print image is applied onto the recording medium 120 by the print head, and the printed recording medium 120 is taken up again onto an additional roll (the take-up) after fixing/drying, or is cut into sheets.

In FIG. 1, the transport direction of the recording medium 120 is represented by an arrow. The printing system 100 thereby typically has only a single transport direction, such that each point of the recording medium 120 is only directed one time past a specific nozzle of the printing system 100. The nozzles may thereby be installed fixed (e.g. immobile) in the printing system 100. The recording medium 120 may be produced from paper, paperboard, cardboard, metal, plastic, textiles, and/or other suitable and printable materials.

In the exemplary embodiment illustrated in FIG. 1, the print group of the printing system 100 comprises four print head arrangements 102 (that are respectively also designated as print bars), but is not limited thereto. The different print head arrangements 102 may be used for printing with inks of different colors (e.g. black, cyan, magenta and/or yellow). The print group may one or more additional print head arrangements 102 for printing additional colors or additional inks (e.g. Magnetic Ink Character Recognition (MICR) ink).

In an exemplary embodiment, a print head arrangement 102 comprises one or more print heads 103. As illustrated in FIG. 1, a print head arrangement 102 can include five respective print heads 103, but is not limited thereto. One or more of the print heads 103 may in turn be subdivided into a plurality of print head segments, wherein each print head segment can include a plurality of nozzles (or one or more nozzles).

In an exemplary embodiment, the installation position/orientation of a print head 103 within a print head arrangement 102 may depend on the type of print head 103. In an exemplary embodiment, one or more (e.g. each) print head 103 comprises multiple nozzles, wherein each nozzle is configured to fire or eject ink droplets onto the recording medium 120. For example, a print head 103 may comprise 2558 effectively used nozzles that are arranged along one or more rows transversal to the transport direction of the recording medium 120, but is not limited thereto. In an exemplary embodiment, the nozzles in the individual rows may be arranged offset from one another. In an exemplary embodiment, a respective line on the recording medium 120 may be printed transversal to the transport direction by means of the nozzles of a print head 103. Via the use of L rows with (transversally offset) nozzles (L>1), an increased resolution may be provided. In total, for example, K=12790 droplets along a transversal line may be fired onto the recording medium 120 via a print head arrangement 102 depicted in FIG. 1 (for example for a print head of approximately 21.25 inches with 600 dpi (dots per inch)). In other words, a print head arrangement 102 may comprise K (for example K=12790) nozzles for printing a line (or transversal line) of a print image, wherein the K nozzles may be arranged in L rows so that each row of nozzles has (on average) K/L nozzles. In an exemplary embodiment, one or more (e.g. each) print head arrangement 102 may be configured to print a transversal line of a specific color onto the recording medium 120 with the K nozzles as needed. The nozzles in the L different rows may thereby be activated with a time offset relative to one another in order to ensure that a transversal line (also designated as a line) is printed by the nozzles.

In an exemplary embodiment, the printing system 100 includes a controller 101 that is configured to activate one or more actuators of the individual nozzles of the individual print heads 103 to apply a print image onto the recording medium 120. The controller 101 can be configured to activate the actuator(s) based on print data. The controller 101 includes activation hardware in an exemplary embodiment. In an exemplary embodiment, the controller 101 includes processor circuitry that is configured to perform one or more operations and/or functions of the controller 101, such as activating one or more actuators.

In an exemplary embodiment, the printing system 100 includes K nozzles that may be activated with a specific activation frequency to print a line (e.g. transversal to the transport direction of the recording medium 120) with K pixels or K columns onto the recording medium 120. In an exemplary embodiment, the nozzles are immobile or installed fixed in the printing system 100, and the recording medium 120 is directed past the stationary nozzles with a defined transport velocity. A defined nozzle thus prints a corresponding defined column (in the transport direction) onto the recording medium 120 (in a one-to-one association). A maximum of one ink ejection thus takes place via a defined nozzle per line of a print image.

FIG. 2 shows a nozzle 200 of a print head 103 according to an exemplary embodiment. In an exemplary embodiment, the nozzle 200 includes walls 202 which, together with an actuator 220, form a container or a pressure chamber 212 to accommodate ink. An ink droplet may be fired onto the recording medium 120 via a nozzle opening 201 of the nozzle 200. The ink forms what is known as a meniscus 210 at the nozzle opening 201. Furthermore, the nozzle 200 includes an actuator 220 (e.g. a piezoelectric element) that is configured to vary the volume of the pressure chamber 212 for accommodating ink or to vary the pressure in the pressure chamber 212 of the nozzle 200. In particular, the volume of the pressure chamber 212 may be reduced, and the pressure in the pressure chamber 212 may be increased, by the actuator 220 as a result of a deflection 222. An ink droplet is thus ejected from the nozzle 200 via the nozzle opening 201. FIG. 2 shows a corresponding deflection 222 of the actuator 220 (dotted lines). Moreover, the volume of the pressure chamber 212 may be increased by the actuator 220 (see deflection 221) in order to draw new ink into the pressure chamber 212 via an ink supply channel 230.

The ink within the nozzle 200 may thus be moved via a deflection 221, 222 of the actuator 220, and the chamber 212 may be placed under pressure. A defined movement of the actuator 220 thereby produces a corresponding defined movement of the ink. The defined movement of the actuator 220 is typically produced via a corresponding defined waveform or a corresponding defined pulse of an activation signal of the actuator 220. In particular, via a fire pulse (also designated as an ejection pulse) to activate the actuator 220 it may be brought about that the nozzle 200 ejects an ink droplet via the nozzle opening 201. Different ink droplets may be ejected via different activation signals to the actuator 220. In particular, ink droplets having different droplet size (for example 5 pl, 7 pl or 12 pl) may thus be ejected. Furthermore, via a pre-fire pulse to activate the actuator 220 it may be produced that, although the nozzle 200 produces a movement of the ink and an oscillation of the meniscus 210, no ink droplet is thereby ejected via the nozzle opening 201.

The different nozzles 200 of a print head 103 or of a print head segment are partially connected with one another, and with an ink reservoir, via one or more ink supply channels 230. Ink may be drawn into the pressure chamber 212 of a nozzle 200 via the ink supply channels 230 (e.g. if the actuator 220 is located in the deflection 221). The nozzles 200 of a print head 103 (or of a print head segment) may thereby mutually influence one another indirectly via the one or more ink supply channels 230.

As presented above, at least a portion of the K nozzles 200 for printing a line of a print image are arranged in parallel in a print head 103 (relative to the transport direction of the recording medium 120). For example, K/L nozzles 200 of a print head 103 may be arranged in a row (transversal to the transport direction). These K/L nozzles 200 may be activated simultaneously to print a line of a print image, and may thereby mutually affect one another due to the connection via the one or more ink supply channels 230.

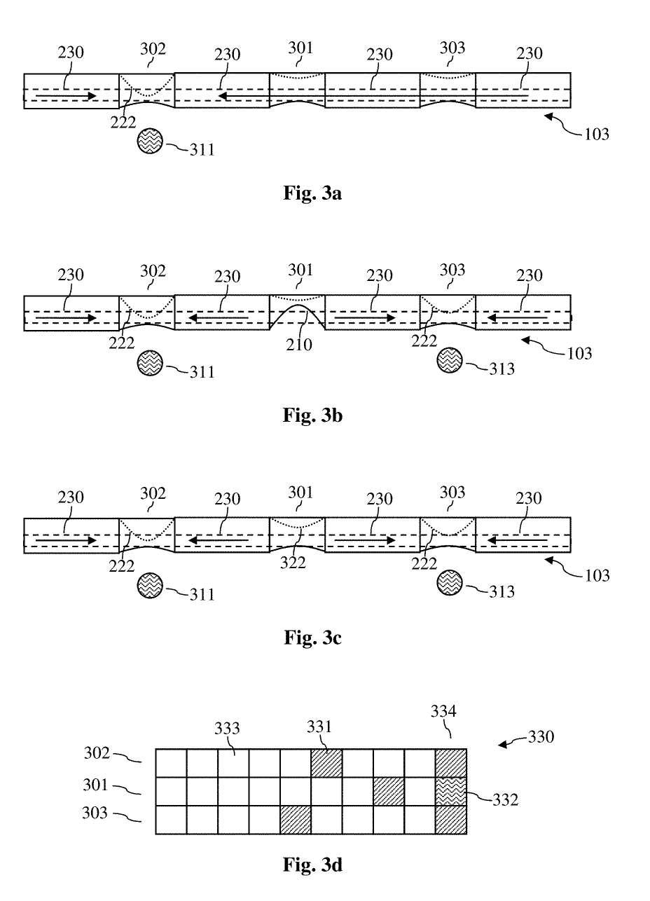

FIG. 3a shows an exemplary arrangement of three nozzles 301, 302, 303 that may be activated simultaneously. In the example presented in FIG. 3a, the first nozzle 301 and the third nozzle 303 should thereby eject no ink at an activation point in time, whereas the second nozzle 302 should eject an ink droplet 311 at the activation point in time (which is illustrated by the dashed deflection 222 of the actuator 220, which is shown relatively large). Within the scope of the ejection of an ink droplet 311, the second nozzle 302 draws ink via the one or more ink supply channels 230 (depicted by the arrows in FIG. 3a).

FIG. 3b shows an example in which the second nozzle 302 and the third nozzle 303 should eject an ink droplet 311, 313 simultaneously at an activation point in time, and for this should draw ink from the one or more ink supply channels 230 (see arrows in FIG. 3b). The first nozzle 301 adjacent to the second and third nozzle 302, 303 should not eject ink droplets at this activation point in time, such that the actuator 220 of the first nozzle 301 is typically not activated with a pulse in order to deflect the actuator 220. The suction of ink by the adjacent second and third nozzle 302, 303 may lead to the situation that ink is drawn from the chamber 212 of the first nozzle 301 via the one or more ink supply channels 230, such that a negative pressure in the chamber 212 of the first nozzle 301 is generated and the meniscus 210 at the nozzle opening 201 of the first nozzle arrangement 301 is thereby drawn inward. Due to the negative pressure in the chamber 212 of the first nozzle 301, air may be drawn into the chamber 212 of the first nozzle 301 via the nozzle opening 201, whereby the ink ejection of the first nozzle 301 in a following print line (meaning at a subsequent activation point in time) may be negatively affected. The ink ejection in one or more adjacent nozzles 302, 303 may thus negatively affect the droplet formation of the first nozzle 301.

In other words, during printing multiple nozzles 301, 302, 303 (for example the nozzles 301, 302, 303 of a row of the print head 103) are often activated simultaneously in said inkjet print head 103. These nozzles 301, 302, 303 may thereby be connected with one another via ink supply channels 230. Especially given print heads 103 with a relatively high image dot density (for example of 1200 dpi), the phenomenon may then result that individual nozzles 301 fail after adjacent nozzles 302, 303 that draw ink from the same print head-internal supply channel 230 have been activated in order to eject ink droplets. This phenomenon is therefore due to the fact that air above the nozzle opening 201 of the unactivated nozzle 301 is drawn inside the nozzle chamber 212, since ink is not sufficiently quickly replenished from the ink supply or from the ink reservoir via the ink supply channel 230 (as illustrated in FIG. 3b). Due to the negative pressure being applied at the print head 103 or at the nozzles 301, 302, 303, these air bubbles may then be drawn further inside the print head 103 within a short time. As a result, multiple nozzles 301, 302, 303 or entire rows of nozzles 301, 302, 303 may fail due to this air inclusion. In particular, this effect may occur when relatively many nozzles 302, 303 are activated at an activation point in time (in order to eject ink droplets) and only individual nozzles 301 are not activated (and thus eject no ink droplets). In particular, the individual unactivated nozzles 301 may then fail due to air inclusions.

The mutual negative effect of nozzles 301, 302, 303 that draw ink from a common ink supply channel 230 typically increases with the increasing number of nozzles 301, 302, 303 that are activated at an activation point in time in order to eject ink droplets. In particular, the pressure fluctuations, and therefore the negative effects, increase with the increasing number of activated nozzles 301, 302, 303 (or with an increasing proportion of activated nozzles 301, 302, 303 to the total number of nozzles 301, 302, 303 of an ink supply channel 230).

In an exemplary embodiment, the failure of nozzles 301 may be counteracted via dedicated purge & wipe intervals for the cleaning and regeneration of nozzles 301, 302, 303. However, this leads to a reduction of the printing speeds and to an increase of the required printing resources (in particular ink).

In an exemplary embodiment, in order to prevent or reduce a negative effect on a first nozzle 301 that should eject no ink at an activation point, the first nozzle 301 may be activated with the activation signal at the activation point in time via which the actuator 220 of the first nozzle 301 is deflected (see deflection 322 in FIG. 3c), such that the negative pressure (produced by the adjacent one or more nozzles 302, 303) is reduced in the pressure chamber 212 of the first nozzle 301 but no ink ejection from the first nozzle 301 is thereby produced. In an exemplary embodiment, in particular, the first nozzle 301 may be activated with pre-fire pulse at the activation point in time in order to reduce the negative pressure in the pressure chamber 212 of the first nozzle 301. The pulse for activation of the first nozzle 301 may generally be designated as a negative pressure reduction pulse.

In an exemplary embodiment, the negative pressure reduction pulse may be generated depending on how the one or more adjacent nozzles 302, 303 of the first nozzle 301 are activated at the activation point in time. The print data 330 for the (simultaneously activated) nozzles 301, 302, 303 may be analyzed for this purpose (see FIG. 3d). Via corresponding activation signals 331, 332, 333, the print data 330 specify whether, at an activation point in time 334, a nozzle 301, 302, 303
should print a “white” pixel, and thus typically is not activated [sic] a pulse (activation signal 333); or
should print a “non-white” pixel, and thus is activated with a fire pulse (activation signal 331).

In an exemplary embodiment, based on the print data 330, it may be determined whether, at a defined activation point in time 334, the (possibly directly) adjacent nozzles 302, 303 of the first nozzle 301 should print a “non-white” pixel while the first nozzle 301 should print a “white” pixel. If this is the case, the print data 330 may be adapted in order to have the effect that the first nozzle 301 is activated with a negative pressure reduction pulse (activation signal 332) at the defined activation point in time 334. Nozzle failures in a print head 103 may thus be avoided reliably and without overheating of the actuators 220 of the individual nozzles 301, 302, 303.

In other words, individual nozzles 301 which do not print at a specific point in time 334 while other nozzles 302, 303 print simultaneously may be activated with a negative pressure reduction pulse (in particular with a pre-fire pulse) (as shown in FIG. 3c) in order to prevent the failure of nozzles 301, 302, 303 of a print head 103. While the nozzles 302, 303 print, ink is resupplied into the pressure chambers 212 of the nozzles 302, 303 via the ink supply channel 230, which may lead to a negative pressure in the print chambers 212 of the one or more non-printing nozzles 301. In the one or more non-printing nozzles 301, the negative pressure reduction pulse may then have the effect that the one or more non-printing nozzles 301 achieve a certain resistance or counter-pressure against the applied negative pressure, and as a result of this no air is drawn into the respective pressure chambers 212 via the nozzle openings 201 of the one or more non-printing nozzles 301. Nozzle failures may thus be prevented.

In an exemplary embodiment, in order to select the one or more nozzles 301 that must be stabilized with a negative pressure reduction pulse at an activation point in time 334, which nozzles 301, 302, 303 are activated at which point in time 334 with which activation signals 331, 333 (as shown in FIG. 3d, for example) may be identified with the aid of a modified pixel preview function (for example on the basis of print data 330). If a certain number of nozzles 302, 303 in a nozzle row are activated with a fire pulse at a defined point in time 334, a decision may be made as to whether one or more unactivated adjacent nozzles 301 should be activated with a negative pressure reduction pulse at the defined point in time 334. Given a non-printing nozzle 301 at an activation point in time 334, a negative pressure reduction pulse may thereby be inserted if the number of (possibly directly adjacent) nozzles 302, 303 that should print a “non-white” pixel at the activation point in time 334 is greater than or equal to a predefined numerical threshold. On the other hand, the insertion of a negative pressure reduction pulse may be omitted.

The probability of the drawing of air into a nozzle 301 typically increases with the increasing number of printing nozzles 302, 303. The numerical threshold may be selected such that the probability of the suction of air is at or below a defined probability threshold.

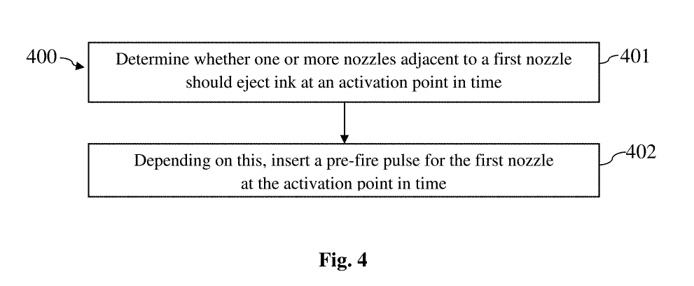

FIG. 4 shows a workflow diagram a method 400 to stabilize the ink meniscus 210 at a nozzle opening 201 of a first nozzle 301 of a print head 103. The pressure chamber 212 of the first nozzle 301 is thereby connected via (at least) one ink supply channel 230 with pressure chambers 212 of one or more adjacent nozzles 302, 303 of the print head 103. The first nozzle 301 and the one or more adjacent nozzles 302, 303 are moreover typically connected via the (at least one) ink supply channel 230 with an ink reservoir from which ink may be conveyed into the pressure chambers 212 of the nozzles 301, 302, 303.

The nozzles 301, 302, 303 designated as adjacent nozzles 301, 302, 303 in this document may be nozzles that are connected with one another via a common ink supply channel 230. In other words, all nozzles 301, 302, 303 of an inkjet printing system 100 that access a common ink supply channel 230 may be designated as nozzles 301, 302, 303 adjacent to one another.

Moreover, there may be gradations in the degree of adjacency between nozzles 301, 302, 303 that attach to a common ink supply channel 230. For example, nozzles 301, 302, 303 may be arranged next to one another (transversal to the transport direction) and be connected to an ink supply channel 230 running transversal to the transport direction. In such an instance, a first nozzle 301 (that is not situated at the edge) has two directly or immediately adjacent nozzles 302, 303 (as shown in FIG. 3a, for example). Moreover, a first nozzle 301 may have still more adjacent nozzles to the left of the second nozzle 302 and/or to the right of the third nozzle 303, which nozzles have a decreasing degree of adjacency with increasing distance from the first nozzle 301, however. In other words: the degree of adjacency of a defined, adjacent nozzle relative to the first nozzle 301 may decrease with the number of nozzles that are situated between the defined adjacent nozzle and the first nozzle 301.

The one or more adjacent nozzles 302, 303 are typically activated simultaneously with the first nozzle 301 at an activation point in time 334, or at a sequence of activation points in time 334, in order to print image points of a print image (or corresponding sequences of image points) on a recording medium 120. For example, the print head 103 may have L rows (arranged transversal to the transport direction) of nozzles 301, 302, 303. The first nozzle 301 and the one or more adjacent nozzles 302, 303 may be part of a row of nozzles 301, 302, 303, or correspond to a row of nozzles 301, 302, 303 of a print head 103.

At the activation point in time, image points may be printed onto a line of the print image by the first nozzle 301 and the one or more adjacent nozzles 302, 303, wherein the image points lie in different columns. A line thereby travels transversal to the transport direction, and a column travels longitudinal to the transport direction. At a sequence of activation points in time 334, the first nozzle 301 and the one or more adjacent nozzles 302, 303 may respectively print a sequence of image points in different columns of the print image.

In an exemplary embodiment, the method 400 includes the determination 401 of whether at least a portion of the one or more adjacent nozzles 302, 303 should eject ink at an activation point in time 334 at which the first nozzle 301 should eject no ink. In other words, it may be determined whether at least a portion of the simultaneously activated one or more adjacent nozzles 302, 303 prints a “non-white” image point (with ink ejection) onto the recording medium 120 at an activation point in time 334 at which the first nozzle 301 prints a “white” image point (without ink ejection) onto the recording medium 120. In such a situation, it may occur that air is drawn into the pressure chamber 212 of the first nozzle 301 via the nozzle opening 210 of the first nozzle 301, which might lead to nozzle failures. The suction of air into the pressure chamber 212 of the first nozzle 301 may in particular take place when the one or more nozzles 302, 303 directly adjacent to the first nozzle 301 eject ink at the activation point in time 334.

In an exemplary embodiment, based on the determination 401, the method 400 additionally includes the activation 402 of the first nozzle 301 at the activation point in time 334 with a negative pressure reduction pulse via which a negative pressure in the pressure chamber 212 of the first nozzle 301 is reduced at least temporarily without, however, thereby producing an ink ejection by the first nozzle 301. For this purpose, an actuator 220 of the first nozzle 301 may in particular be activated with the negative pressure reduction pulse at the activation point in time 334 in order to at least temporarily reduce the volume of the pressure chamber 212 of the first nozzle 301 so that the negative pressure in the pressure chamber 212 of the first nozzle 301 is reduced. It may thus be avoided that, during a printing pause of the first nozzle 301, air is suctioned via the nozzle opening 310 of the first nozzle 301 due to the activation of the one or more adjacent nozzles 302, 303, which might lead to nozzle failures.

The first nozzle 301 and the one or more adjacent nozzles 302, 303 may typically be activated simultaneously at a sequence of activation points in time 334 in order to respectively print a corresponding sequence of image points of the print image on the recording medium 120. The activation points in time 334 of the sequence of activation points in time 334 may thereby follow in series with an activation frequency (or with a line clock) in order to print image points of different lines onto the recording medium 120 with the activation frequency. The time interval between two successive activation points in time 334 of the sequence of activation points in time 334 thereby corresponds to the time period that is provided to a nozzle 301, 302, 303 in order to print the image point of a line of a print image.

The actuator 220 of a nozzle 301, 302, 303 may be activated or excited with an ejection pulse (or fire pulse), wherein the ejection of ink from the nozzle opening 210 of the nozzle 301, 302, 303 is produced by the ejection pulse. Within the time interval between two successive activation points in time 334, an ejection pulse thereby typically includes a first phase in which the volume of the pressure chamber 212 of the nozzle 301, 302, 303 is increased and a second phase in which the volume of the pressure chamber 212 of the nozzle 301, 302, 303 is reduced. A negative pressure in the pressure chamber 212 of a different nozzle 301 may be caused via the ink supply channel 230 due to the increase of the volume in the pressure chamber 212 of a nozzle 302.

In other words, to eject ink the volume of the pressure chamber 212 of a nozzle 301, 302, 303 may be increased at least temporarily, during the time interval between two successive activation points in time 334, in order to draw ink into the pressure chamber 212 of the nozzle 301, 302, 303 via the ink supply channel 230. A negative pressure may thereby be generated in the pressure chamber 212 of a different nozzle, in particular in the pressure chamber 212 of the first nozzle 301.

The negative pressure reduction pulse may be designed such that, via the negative pressure reduction pulse, the negative pressure in the pressure chamber 212 of a nozzle 301, 302, 303 is at least temporarily reduced during the time interval between two successive activation points in time 334 of the sequence of activation points in time 334. In particular, the negative pressure reduction pulse may be designed such that the negative pressure in the pressure chamber 212 of a nozzle 301, 302, 303 is reduced in the first phase of an ejection pulse. The intake of air via the nozzle opening 201 of a non-printing nozzle 301, 302, 303 may thus be particularly effectively avoided.

The first nozzle 301 and the one or more adjacent nozzles 302, 303 respectively comprise a pressure chamber 212 and an actuator 220 via which the volumes of the respective pressure chambers 212 may be varied. The actuators 220 of the first nozzle 301 and of the one or more adjacent nozzles 302, 303 may respectively be activated at an activation point in time 334 with one activation signal 331, 333 from a plurality of different activation signals 331, 333 (for example M different activation signals, for example with M=4 or 8). For example, the number of different activation signals 331, 333 may be established by a maximum number of bits (for example 2 or 3 bits) for the activation signals 331, 333. With which activation signal 331, 333 the nozzle 301, 302, 303 is activated may then be communicated to a nozzle 301, 302, 303 via a bit sequence. In particular, the pulse or the waveform for the actuator 220 of a nozzle 301, 302, 303 may be indicated by the activation signal 331, 333.

In an exemplary embodiment, the plurality of activation signals 331, 333 may include: a first activation signal 331 (for an ejection pulse) via which the volume of the pressure chamber 212 of a nozzle 301, 302, 303 is varied (during the time interval between two successive activation points in time 334) such that an ink droplet is ejected through the nozzle opening 201 of the nozzle 301, 302, 303; a second activation signal 333 via which the volume of the pressure chamber 212 of a nozzle 301, 302, 303 remains unchanged (during the time interval between two successive activation points in time 334); and a third activation signal (for a pre-ejection pulse, for example) via which the volume of the pressure chamber 212 of a nozzle 301, 302, 303 is varied (during the time interval between two successive activation points in time 334) such that, although the ink meniscus 210 moves, no ink droplet is ejected through the opening 201 of the nozzle 301, 302, 303.

In an exemplary embodiment, the third activation signal may thereby correspond to a pre-fire pulse via which the ink meniscus 210 at the nozzle opening 201 of a nozzle 301, 302, 303 is moved in order to reduce the viscosity of the ink within the pressure chamber 212 of the nozzle 301, 302, 303. In other words, the ink meniscus 210 at the nozzle opening 201 of a nozzle 301, 302, 303 may be vibrated by the pre-fire pulse in order to mix ink in the pressure chamber 212 or in a region of the ink meniscus 210 of the nozzle 301, 302, 303 so that the viscosity of the ink within the pressure chamber 212 or in the region of the ink meniscus 210 of the nozzle 301, 302, 303 increases more slowly. Furthermore, the third activation signal 332 may correspond to the negative pressure reduction pulse. The use of the pre-fire pulse to reduce the negative pressure in the pressure chamber 212 of the first nozzle 301 is advantageous since nozzle failures may thus be avoided in a more data/bit-efficient manner (without needing to define an additional specific activation signal with a separate data code for a negative pressure reduction pulse).

In an exemplary embodiment, the determination 401 may include the analysis of print data 330 that indicate the activation signals 331, 333 for the one or more adjacent nozzles 302, 303. The print data 330 for the first nozzle 301 for the activation point in time 334 may thereby indicate the second activation signal 333. In particular, on the basis of the print data 330 it may be determined that the first nozzle 301 should be activated with the second activation signal 333 at the activation point in time 334.

In an exemplary embodiment, the method 400 may include the changing of print data 330 so that the print data 330 for the first nozzle 301 indicate the third activation signal 332 for the activation point in time 334 if it has been determined that the first nozzle 301 should be activated with a negative pressure reduction pulse at the activation point in time 334. Nozzle failures may thus be efficiently avoided by changing the print data 330.

In an exemplary embodiment, the method 400 may include the determination of a number of the one or more adjacent nozzles 302, 303 that should eject ink at the activation point in time 334. The first nozzle 301 may be activated with a negative pressure reduction pulse at the activation point in time 334 (possibly only) when the determined number is greater than or equal to a numerical threshold. The numerical threshold may thereby correspond to a proportion of 50% or more of the one or more adjacent nozzles 302, 303. A selective activation of the first nozzle 301 with a negative pressure reduction pulse may thus take place so that an overheating of the actuators 220 of the nozzles 301, 302, 303 may be avoided (while simultaneously avoiding nozzle failures).

In an exemplary embodiment, alternatively or additionally, the method 400 may include the determination of a degree of adjacency of the one or more adjacent nozzles 302, 303 that should eject ink at the activation point in time 334. In particular, a degree of adjacency may be determined for each of the one or more ejecting adjacent nozzles 302, 303. Furthermore, a (possibly weighted) mean degree of the adjacency of the one or more ejecting nozzles 302, 303 may possibly be determined. The first nozzle 301 may then be activated with a negative pressure reduction pulse at the activation point in time 334 depending on the (possibly mean) degree of adjacency of the one or more ejecting adjacent nozzles 302, 303. For example, an activation with a negative pressure reduction pulse may possibly take place only when the determined (possibly mean) degree of adjacency reaches or exceeds a predefined adjacency threshold. For example, the first nozzle 301 may possibly be activated with a negative pressure reduction pulse only when at least one or at least both of the directly adjacent nozzles 302, 303 should eject ink. In an exemplary embodiment, alternatively or additionally, a property (e.g. a shape) of the negative pressure reduction pulse may be adapted based on the determined (e.g. mean) degree of adjacency. The negative pressure produced in the first nozzle 301 typically decreases with decreasing (possibly mean) degree of adjacency. The pressure produced by the negative pressure reduction pulse in the pressure chamber 212 of the first nozzle 301 may correspondingly decrease with decreasing (possibly mean) degree of adjacency. The print quality and the droplet formation may thus be further improved.

In an exemplary embodiment, the controller 101 and/or 105 of a print head 103 of an inkjet printing system 100 may be configured to execute the method 400. In particular, the controller 101 and/or 105 may be configured to determine whether at least a portion of the one or more adjacent nozzles 302, 303 should eject ink at an activation point in time 334 at which the first nozzle 301 should not eject ink. Depending on this, the controller 101, 105 may then activate the first nozzle 301 at the activation point in time 334 with a negative pressure reduction pulse via which a negative pressure in the pressure chamber 212 of the first nozzle 301 is reduced without producing an ink ejection. In particular, depending on the determination 401 it may be determined whether the first nozzle 301 should be activated or not with a negative pressure reduction pulse at the activation point in time 334. The insertion of a negative pressure reduction pulse may thereby depend
on the number of adjacent nozzles 302, 303 that should eject ink at the activation point in time 334; and/or
on the arrangement of the adjacent nozzles 302, 303 relative to the first nozzle 301.

A method 400 and a corresponding controller 101, 105 are thus described in which one or more non-printing first nozzles 301 are induced to generate a negative pressure reduction pulse—in particular a pre-fire pulse—at an activation point in time 334 depending on the number and/or position of adjacent nozzles 302, 303 that eject ink at the activation point in time 334.

The method according to an exemplary embodiment enables nozzle failures during the printing operation to be prevented or reduced, and thus enables the print quality of a printing system 100 to be increased. Furthermore, load fluctuations within a print head 103 may be compensated for, and crosstalk between the nozzles 301, 302, 303 of a print head 103 may be reduced. Moreover, the productivity of a printing system 100 may be increased and the resource consumption (in particular of ink) may be reduced, since refresh measures may be reduced or entirely avoided.

In an exemplary embodiment, a computer readable medium (e.g. memory, hard drive, disc, etc.) is provided that stores computer code and/or instructions, that when executed by a processor, controls the processor to perform one or more methods of the present disclosure.

### Conclusion

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

100 printing system

101 controller of the printing system 100

102 print head arrangement/print bar

103 print head

105 controller of the print head arrangement

120 recording medium

200, 301, 302, 303 nozzle

201 nozzle opening

202 wall

210 meniscus

212 chamber

220 actuator (piezoelectric element)

221, 222, 322 deflection of the actuator

230 ink supply channel

330 print data

331 activation signal for the printing of a “non-white” pixel

332 activation signal for a negative pressure reduction pulse

333 activation signal for the printing of a “white” pixel

334 activation point in time

400 method for stabilizing the ink meniscus of a nozzle

401, 402 method steps

1. A method to stabilize the ink meniscus at a nozzle opening of a first nozzle of a print head including the first nozzle and one or more adjacent nozzles to the first nozzle, the method comprising:
determining whether at least one of the one or more adjacent nozzles to the first nozzle of the print head is to eject ink at an activation time at which the first nozzle is to eject no ink, wherein a pressure chamber of the first nozzle is connected via an ink supply channel with pressure chambers of the one or more adjacent nozzles; and
simultaneously activating the first nozzle and the one or more adjacent nozzles at the activation time to print image points of a print image onto a recording medium, wherein, based on the determination, the first nozzle is activated at the activation time with a negative pressure reduction pulse to reduce a negative pressure in the pressure chamber of the first nozzle at least temporarily without producing an ink ejection.

2. The method according to claim 1, wherein:
the first nozzle and the one or more adjacent nozzles each comprise an actuator configured to vary a volume of their respective pressure chambers;
the actuators of the first nozzle and the one or more adjacent nozzles may respectively be activated at the activation time with a plurality of different activation signals;
the plurality of activation signals comprise:
a first activation signal that is configured to vary the volume of the respective pressure chamber such that an ink droplet is ejected through a nozzle opening of the one or more adjacent nozzles or the nozzle opening of the first nozzle;
a second activation signal via which the volume of the respective pressure chamber remains unchanged; and
a third activation signal that is configured to reduce the volume of the respective pressure chamber such that no ink droplet is ejected through the nozzle opening of the one or more adjacent nozzles or the nozzle opening of the first nozzle; and
the third activation signal corresponds to the negative pressure reduction pulse.

3. The method according to claim 2, wherein the third activation signal corresponds to a pre-fire pulse via which the ink meniscus at the respective nozzle opening is vibrated to intermix ink in the respective pressure chamber so that the viscosity of the ink within the respective pressure chamber increases more slowly.

4. The method according to claim 2, wherein:
the determination of whether the at least one of the one or more adjacent nozzles to the first nozzle of the print head is to eject ink at the activation time at which the first nozzle is to eject no ink comprises analyzing print data indicative of the plurality of activation signals for the one or more adjacent nozzles;
print data for the first nozzle for the activation time indicates the second activation signal; and
the method further comprises modifying, if the first nozzle is to be activated with the negative pressure reduction pulse at the activation time, the print data for the first nozzle to indicate the third activation signal for the activation time.

5. The method according to claim 1, wherein:
the method further comprises: determining a number of the one or more adjacent nozzles that are to eject ink at the activation time; and
the first nozzle is activated at the activation time with the negative pressure reduction pulse if the determined number is greater than or equal to a numerical threshold.

6. The method according to claim 5, wherein the numerical threshold corresponds to a proportion of 50% or more of the one or more adjacent nozzles.

7. The method according to claim 1, wherein:
the first nozzle and the one or more adjacent nozzles are activated simultaneously at a sequence of activation points in time to respectively print a corresponding sequence of image points of the print image onto the recording medium;
activation points in time of the sequence of activation points in time follow successively with an activation frequency to print the sequence of image points onto the recording medium with the activation frequency; and
the negative pressure in the pressure chamber of the first nozzle is at least partially reduced by the negative pressure reduction pulse during a time interval between two successive activation points in time of the sequence of activation points in time.

8. The method according to claim 7, wherein:
an ejection pulse that is configured to provide an ejection of ink from the nozzle opening of a respective one of the first nozzle and the one or more adjacent nozzles comprises:
a first phase within the time interval between two successive activation points in time, wherein a volume of the pressure chamber of a respective one of the first nozzle and the one or more adjacent nozzles is increased in the first phase, and
a second phase in which the volume of the pressure chamber of the respective one of the first nozzle and the one or more adjacent nozzles is reduced; and
the negative pressure reduction pulse is configured such that the negative pressure in the pressure chamber of the first nozzle is reduced in the first phase.

9. The method according to claim 1, wherein:
a volume of the pressure chamber of the one or more adjacent nozzles is temporarily increased to eject ink to draw ink into the pressure chamber of the one or more adjacent nozzles via the ink supply channel; and
the negative pressure is generated in the pressure chamber of the first nozzle.

10. A computer program product embodied on a computer-readable medium comprising program instructions, when executed, causes a processor to perform the method of claim 1.

11. An inkjet printing system configured to perform the method of claim 1.

12. An inkjet printing system comprising a printer controller, the printer controller being configured to perform the method of claim 1.

13. Controller for a print head of an inkjet printing system, the print head including a first nozzle and one or more adjacent nozzles, wherein a pressure chamber of the first nozzle is connected via an ink supply channel with pressure chambers of the one or more adjacent nozzles, the controller being configured to:
determine whether at least a portion of the one or more adjacent nozzles is to eject ink at an activation time at which the first nozzle is to eject no ink; and
simultaneously activate the first nozzle and the one or more adjacent nozzles at the activation point in time to print image points of a print image onto a recording medium,
wherein, based on the determination, the controller is configured to activate the first nozzle at the activation time with a negative pressure reduction pulse to reduce a negative pressure in the pressure chamber of the first nozzle without producing an ink ejection.
